(19) United States
(12) Patent Application Publication
(10) Pub. No.: US 2008/0241672 A1
(43) Pub. Date: Oct. 2, 2008

(54) NONAQUEOUS ELECTROLYTIC SOLUTION SECONDARY BATTERY AND METHOD FOR PREPARING THE SAME

(75) Inventors: Hisayuki UTSUMI, Nara-shi (JP); Motoaki Nishijima, Kitakatsuragi-gun (JP); Shinsuke Kobayashi, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 12/056,629

(22) Filed: Mar. 27, 2008

(30) Foreign Application Priority Data
Mar. 29, 2007 (JP) 2007-088214

(51) Int. Cl. H01M 2/02; H01M 10/36

(52) U.S. Cl. 429/163; 156/145

(57) ABSTRACT

To provide a secondary battery that is capable of shortening injecting time for injecting an electrolytic solution, and infiltrating the electrolytic solution uniformly, during a process for preparing the secondary battery. Also, to provide the secondary battery in which discordance of layers of positive-electrode plates, negative-electrode plates, and separators does not easily occur during a process for laminating them and the following process.

A nonaqueous electrolytic solution secondary battery of the present invention comprises: negative-electrode plates which are rectangular; positive-electrode plates which each have a pair of opposed sides shorter than a pair of opposed sides of each negative-electrode plate; separators which each are formed of a porous resin film enclosing each positive-electrode plate; an enclosure which encloses the negative-electrode plates and separators which are laminated alternately, in which a direction of the sides of the negative-electrode plates aligns with a direction of the shorter sides of the positive-electrode plates; and an injection pathway for the nonaqueous electrolytic solution, which the pathway being formed between the negative-electrode plates between which the separator is sandwiched, the pathway being formed at edges of opposed sides of the negative-electrode plates.

### CROSS-REFERENCE TO RELATED APPLICATION

This application is related to Japanese Patent Application No. 2007-88214 filed on Mar. 29, 2007, whose priority is claimed under 35 USC §119, the disclosure of which is incorporated by reference in its entirety.

### BACKGROUND OF THE INVENTION

1. Field of the Invention

The present invention relates to a nonaqueous electrolytic solution secondary battery in which positive-electrode plates, separators, and negative-electrode plates are laminated, and a method for preparing the battery. More specifically, the present invention relates to a large-scale nonaqueous electrolytic solution secondary battery and a method for preparing the large-scale battery.

2. Description of the Related Art

A large-scale nonaqueous electrolytic solution secondary battery has a problem with injecting time for injecting the electrolytic solution during a process for injecting the electrolytic solution between a positive-electrode plate and a negative-electrode plate, due to large areas of the electrode plates, and also has a problem with discordance of layers during a process for laminating the electrode plates.

For example, Japanese Unexamined Patent Application Publication No. 2004-14355 discloses the invention relating to sizes of a positive-electrode plate, a negative-electrode plate, and a separator. Japanese Unexamined Patent Application Publication No. 2004-14355 discloses a structure in which the separator protrudes in a width direction thereof by a length of 1.5 mm to 2.5 mm from an edge of either the positive-electrode plate or the negative-electrode plate which has a longer width than that of the other.

Also, Japanese Unexamined Patent Application Publication No. HEI 7(1995)-272761 and Japanese Unexamined Patent Application Publication No. HEI 10(1998)-188938 disclose a technique for sandwiching a positive-electrode plate or a negative-electrode plate between two separators Japanese Unexamined Patent Application Publication No. HEI 7(1995)-272761 discloses that the positive-electrode plate or the negative-electrode plate is sandwiched between the two separators, and the peripheries of the two separators around the positive-electrode plate or the negative-electrode plate are fused at prescribed intervals. Japanese Unexamined Patent Application Publication No. HEI 10(1998)-188938 discloses that the positive-electrode plate or the negative-electrode plate is sandwiched between the two separators, and four corners of the two separators around the positive-electrode plate or the negative-electrode plate are fused so as to form a sac-like shape.

Japanese Unexamined Patent Application Publication No. 2004-14355 discloses the invention of a battery in which the belt-like positive-electrode plate and the belt-like negative-electrode plate are laminated with the belt-like separator therebetween, and are wound, and the battery uses a solid electrolyte. This battery has the structure in which the separator protrudes in its width direction by the length of 1.5 mm to 2.5 mm from the edge of either the positive-electrode plate or the negative-electrode plate. As a result, even though the separator is crushed by being dropped or stressed, a protruded part of the separator retains a sufficient distance in an axial direction of the battery, and therefore the separator properly shields the positive-electrode plate and the negative-electrode plate from each other so as to prevent an internal short-circuit.

Also, the separators of Japanese Unexamined Patent Application Publication No. HEI 7(1995)-272761 are prevented from being creased since the peripheries of the separators around the positive-electrode plate or the negative-electrode plate are fused at the prescribed intervals, and the separators of Japanese Unexamined Patent Application Publication No. HEI 10(1998)-188938 are also prevented from being creased since the four corners of the separators around the positive-electrode plate or the negative-electrode plate are fused.

Here, the sizes of the positive-electrode plate, the negative-electrode plate, and the separator in the nonaqueous electrolyte secondary battery of Japanese Unexamined Patent Application Publication No. 2004-14355 are disclosed such that the positive-electrode plate has 50 mm in width and 350 mm in length, the negative-electrode plate has 51.5 mm in width and 355 mm in length, and the separator protrudes in its width direction by the length of 1.5 mm to 2.5 mm from the edge of the negative-electrode plate, and a discharged capacity of the battery is 833 mAh.

Also, a secondary battery of Japanese Unexamined Patent Application Publication No. HEI 10(1998)-188938 has the positive-electrode plate and the negative-electrode plates both having a width of 45 mm and a length of 100 mm, and the separators having a slightly longer length and width than those of the positive-electrode plate. The sizes disclosed in Japanese Unexamined Patent Application Publication No. HEI 10(1998)-188938 bring about relatively short injecting time for injecting an electrolytic solution, and the secondary battery does not have a problem with a process for preparing the battery. However, the large-scale nonaqueous electrolytic solution secondary battery has extremely long injecting time for injecting the electrolytic solution, and has a problem with a process for preparing the battery. The large-scale nonaqueous electrolytic solution secondary battery also has a problem of infiltrating the electrolytic solution uniformly. Further, since the large-scale nonaqueous electrolytic solution secondary battery is necessary to have a plurality of positive-electrode plates, negative-electrode plates, and separators, which are laminated, each being large in size, the discordance of the layers during the process for laminating the positive-electrode plates, the negative-electrode plates, and the separators easily occurs, due to large areas thereof.

### SUMMARY OF THE INVENTION

The present invention is to solve the above-mentioned problems, and has an object of providing a secondary battery that is capable of shortening injecting time for injecting an electrolytic solution, and infiltrating the electrolytic solution uniformly, during a process for preparing the secondary battery. Also, the present invention has another object of providing the secondary battery in which discordance of layers of positive-electrode plates, negative-electrode plates, and separators does not easily occur during a process for laminating them and the following process.

To solve the above-mentioned problems, a nonaqueous electrolytic solution secondary battery set forth in the present invention comprises: negative-electrode plates which are rectangular; positive-electrode plates which each have a pair of opposed sides shorter than a pair of opposed sides of each negative-electrode plate; separators which each are formed of a porous resin film enclosing each positive-electrode plate; an enclosure which encloses the negative-electrode plates and separators which are laminated alternately, in which a direction of the sides of the negative-electrode plates aligns with a direction of the shorter sides of the positive-electrode plates; and an injection pathway for the nonaqueous electrolytic solution, which the pathway being formed between the negative-electrode plates between which the separator is sandwiched, the pathway being formed at edges of opposed sides of the negative-electrode plates.

In the present specification, a rectangle includes a square.

Since the electrolytic solution is injected through the injection pathway according to a structure described above, the injecting time for injecting the electrolytic solution can be shortened.

### BRIEF DESCRIPTION OF THE DRAWINGS

FIG. 1 is a development view of a positive-electrode plate, a negative-electrode plate, and a separator constituting a secondary battery of the present invention;

FIG. 2 shows a laminated structure of a secondary battery of the present invention;

FIG. 3 is a cross-section view of a secondary battery prepared according to the present invention;

FIG. 4 shows a flow process chart describing a process for preparing a secondary battery of the present invention;

FIG. 5 shows measurement results of Examples 1 to 3 and Comparative Examples 1 and 2; and

FIG. 6 shows measurement results of alternating-current impedances of Examples 1 to 3 and Comparative Examples 1 and 2.

### DESCRIPTION OF THE PREFERRED EMBODIMENTS

The nonaqueous electrolytic solution secondary battery set forth in the present invention is characterized in the embodiments in that a length of the pair of the opposed sides of each positive-electrode plate is shorter by a length of 4 mm to 10 mm than a length of the pair of the opposed sides of each negative-electrode plate.

Accordingly, the injection pathway for effectively injecting the electrolytic solution can be formed, and also the size of a part which does not serve for power generation can be reduced

Also, the nonaqueous electrolytic solution secondary battery set forth in the present invention is characterized in the embodiments in that each separator has a length of a pair of opposed sides which is almost the same as the length of the pair of the opposed sides of each negative-electrode plate.

Accordingly, discordance of layers of the positive-electrode plates, each being enclosed with the separator, and the negative-electrode plates does not easily occur during a process for laminating them alternately, the lamination process can be smoothly executed, and the discordance of the layers does not easily occur even during the following process.

Further, the nonaqueous electrolytic solution secondary battery set forth in the present invention is characterized in the embodiments in that a capacity of each positive-electrode plate is 3 Ah to 5 Ah per plate, and a battery capacity of the nonaqueous electrolytic solution secondary battery is 5 Ah to 150 Ah.

According to the present invention, injecting time for injecting the electrolytic solution can be shortened even during a process for injecting the electrolytic solution into a large-scale nonaqueous electrolytic solution secondary battery.

Furthermore, the nonaqueous electrolytic solution secondary battery set forth in the present invention is characterized in the embodiments in that an electric capacity of each positive-electrode plate is 2 mAh to 12 mAh per square centimeter.

According to the present invention, the injecting time for injecting the electrolytic solution can be shortened even during the process for injecting the electrolytic solution into the large-scale nonaqueous electrolytic solution secondary battery.

Additionally, the nonaqueous electrolytic solution secondary battery set forth in the present invention is characterized in the embodiments in that the periphery of each separator is fused.

Accordingly, each positive-electrode plate can be positioned inside each separator, and the position of the positive-electrode plate does not shift.

Also, the nonaqueous electrolytic solution secondary battery set forth in the present invention is characterized in the embodiments in that each separator has fused sections and unfused sections which are alternately positioned at the periphery of the separator, in which a length of each fused section is 0.1 mm to 20 mm, and a length of each unfused section is 0.5 mm to 100 mm.

Since the separator has the fused sections and the unfused sections as described above, the electrolytic solution infiltrates through the unfused sections, and the injecting time for injecting the electrolytic solution can be shortened.

Further, the nonaqueous electrolytic solution secondary battery set forth in the present invention is characterized in the embodiments in that one of the pair of the opposed sides of each separator is open, the side facing the shorter side of the positive-electrode plate, and other sides of the separator are fused.

Accordingly, the electrolytic solution can be also injected through the opening of the separator, and therefore the injecting time for injecting the electrolytic solution can be shortened.

Another aspect of the present invention is a method for preparing the nonaqueous s electrolytic solution secondary battery, comprising the steps of: alternately laminating the negative-electrode plates and separators, each separator enclosing one positive-electrode plate having the pair of the opposed sides shorter than the pair of the opposed sides of each negative-electrode plate, enclosing a laminated body with the enclosure having an injection opening for the electrolytic solution, the laminated body being laminated during the lamination step; injecting the electrolytic solution through the injection opening to infiltrate the electrolytic solution between the negative-electrode plate and the positive-electrode plate through the injection pathway formed at the edges of the opposed sides of the negative-electrode plates; and sealing the injection opening.

Accordingly, the injecting time for injecting the electrolytic solution can be shortened, and the nonaqueous electrolytic solution secondary battery can be prepared within the shortened injecting time.

Hereinafter, the nonaqueous electrolytic solution secondary battery of the present invention will be described in detail.

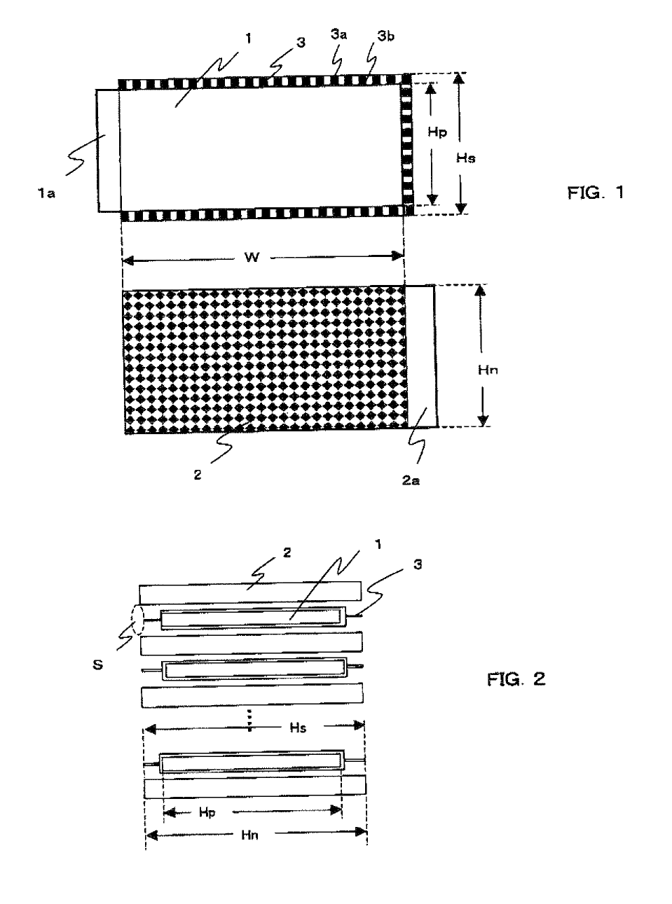

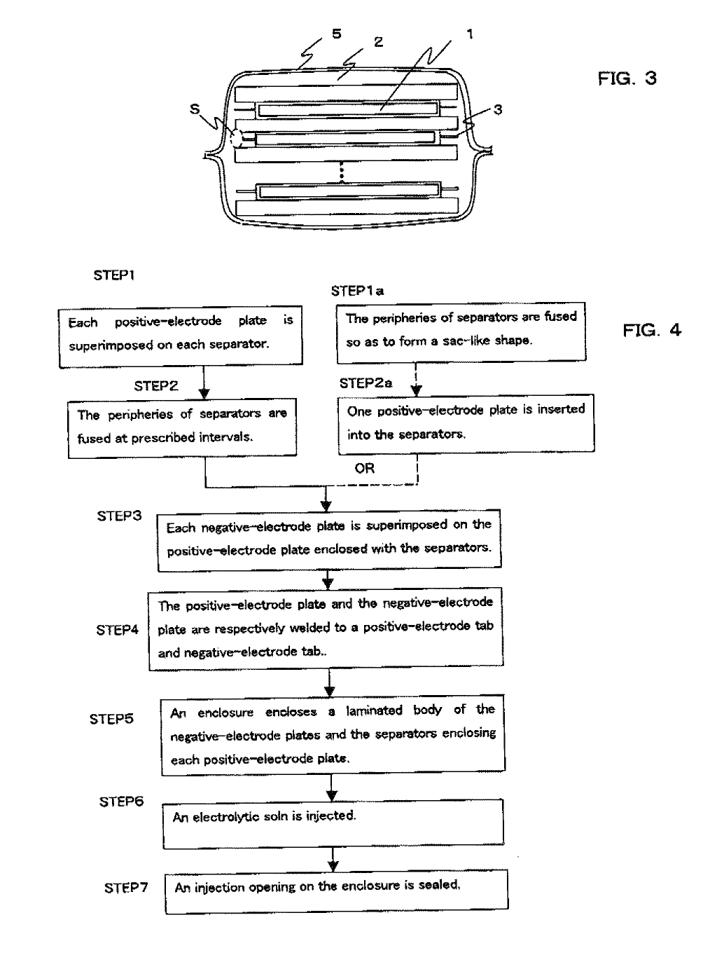

FIG. 1 shows a structure of a lithium ion secondary battery as an example of the nonaqueous electrolytic solution secondary battery. A form of an enclosure 5 of the lithium ion secondary battery is applicable to both a rectangular type and a thin type, and a form of each of the positive-electrode plates, negative-electrode plates, and separators is determined according to the form of the enclosure 5. FIG. 1 shows a development view of a separator 3 enclosing a positive-electrode plate 1, and a negative-electrode plate 2 of the present invention, and FIG. 2 shows a laminated structure thereof. FIG. 3 shows a cross-section view of the lithium ion secondary battery in which the laminated body is stored in the enclosure 5. The positive-electrode plate 1 and the negative-electrode plate 2 shown in FIG. 1 are rectangular, but may be square.

The positive-electrode plate 1 is prepared such that a paste containing a positive active material, a conductive material, a binder, and an organic solvent is applied on a positive current collector, dried, and pressurized.

As the positive active material, there can be used, for example, LiNiO₂, LiCoO₂, LiMn₂O₄ and the like, their lithium oxide composites, and compounds in which an element(s) of the compounds above are substituted with other element(s).

As the conductive material, for example, a carbonaceous material such as acetylene black, Ketjen Black and the like can be added to the paste. Also, well-known additives and the like can be added.

As the binder, there can be used, for example, polyvinylidene-fluoride, polyvinylpyridine, polytetrafluoroethylene and the like.

As the organic solvent, there can be used N-methyl-2-pyrrolidone (NMP), N,N-dimethylformamide (DMF) and the like.

As the positive current collector, there can be used, for example, a conductive metal foil or a thin plate formed of SUS, aluminum and the like.

The separator 3 enclosing the positive-electrode plate 1 is formed of a porous film. In consideration of the solvent resistance and the oxidation-reduction resistance, a porous film or a nonwoven fabric formed of a polyolefin resin such as polyethylene, polypropylene and the like is desirable. The porous film or the nonwoven fabric formed of such a material above is used in the form of a single layer or multiple layers. In the case when the multiple layers are used, at least one layer of the nonwoven fabric is preferable to be used.

The negative-electrode plate 2 is prepared such that a paste containing a negative active material, a conductive material, a binder, and an organic solvent is applied on a negative current collector, dried, and pressurized.

As the negative active material, there can be used, for example, pyrolytic carbons, cokes, graphites, glass-like carbons, a sintered body of organic polymer compounds, carbon fibers, activated carbon and the like.

As the conductive material, for example, a carbonaceous material such as acetylene black, Ketjen Black and the like can be added to the paste. Also, well-known additives and the like can be added.

As the binder, there can be used, for example, polyvinylidene-fluoride, polyvinylpyridine, polytetrafluoroethylene and the like.

As the organic solvent, there can be used N-methyl-2-pyrrolidone (NMP), N,N-dimethylformamide (DMF) and the like.

As the negative current collector, there can be used a metal foil formed of copper and the like.

Also, as the nonaqueous electrolytic solution used in the present invention, there can be used a solution in which electrolytic salt dissolves in an organic solvent.

As the electrolytic salt, salt formed of lithium as a cation component, and an inorganic acid such as hydrofluoroboric acid, hydrofluoric acid, hexafluorophosphate, perchloric acid and the like and an organic acid such as fluoro-substituted organic sulfonic acid and the like, as an anion component can be used.

As the organic solvent as the electrolytic solution, there can be used any solvents in which the electrolytic salt above can dissolve. For example, cyclic esters such as ethylene carbonate, propylene carbonate, butylene carbonate, γ-butyrolactone and the like, ethers such as tetrahydrofuran, dimethoxyethane and the like, and linear esters such as dimethyl carbonate, diethyl carbonate, ethylmethyl carbonate and the like can be exemplified. These organic solvents can be used alone or as a mixture of two or more solvents.

The enclosure 5 is a laminated film formed with two or more layers of, for example, a resin layer and a metal layer, the film being laminated by the lamination, and the resin layer is positioned to face the laminated body. As the resin layer, there can be used, for example, polyethylene, polypropylene, modified polyethylene, modified polypropylene, a polymer of these compounds, and an organic resin material having a polyolefin resin and the like. Also, as the metal layer, there can be used, for example, aluminum, stainless, nickel, iron and the like, which are formed in the form of a plate or film.

Each material described above is an example, and is not limited in the present invention, and therefore any materials known for the lithium ion secondary battery can be used.

The nonaqueous electrolytic solution secondary battery of the present invention is applicable to a nonaqueous electrolytic solution secondary battery having relatively large electrode areas. For example, a capacity per plate of the positive-electrode plate is from 3 Ah or more to 5 Ah or less. When the capacity is 3 Ah or less, it causes an inconvenience that the number of the laminated electrodes needs to be increased so as to increase the battery capacity. The capacity of 5 Ah or more is practically difficult. Therefore, the preferable capacity is 3 Ah to 5 Ah.

Because the plurality of the separators, each separator enclosing one positive-electrode plate as described above, and the negative-electrode plates are alternately laminated, the secondary battery having the battery capacity from 5 Ah or more to 150 Ah or less is prepared. When the battery capacity is 5 Ah or less, the large-scale secondary battery at which the present invention aims cannot be obtained, and the secondary battery having the battery capacity of 5 Ah or less has short injecting time for injecting the electrolytic solution. Therefore, a significant effect of shortening infiltrating time for infiltrating the electrolytic solution due to the structure of the present invention cannot be obtained. Also, the secondary battery having the battery capacity of 150 Ah or more is practically difficult. Accordingly, the battery capacity of 6 Ah to 120 Ah is more preferable.

The positive-electrode plate as described above is desirable to be, for example, 150 mm to 500 mm long, 150 mm to 750 mm wide, and 50 μm to 200 μm thick, and has 22,500 mm² to 375,000 mm² in area.

The large-scale secondary battery having such a high capacity brings about extremely long injecting time for injecting the electrolytic solution, and is not suitable to be prepared in large volume. Therefore, the present invention has an electrode structure which can shorten the injecting time for injecting the electrolytic solution.

Namely, as shown in FIGS. 1 and 2, a length of the shorter side of the rectangular positive-electrode plate 1 enclosed with the separator is determined as Hp (mm), and a length of the shorter side of the rectangular negative-electrode plate 2 is determined as Hn (mm). Then, a relationship thereof is to be Hp<Hn, and 4 (mm)≦Hn−Hp≦10 (mm). Further, a space S is formed at an edge of the positive-electrode plate and between the negative-electrode plates where the negative-electrode plates do not face the positive-electrode plate, the space having a width of (Hn−Hp), and the space is a part of the injection pathway for the electrolytic solution. Therefore, the width of Hn−Hp is an entire size of the injection pathway at both edges of the positive-electrode plate. When a difference between the length Hp (mm) of the shorter side of the positive-electrode plate 1 and the length Hn (mm) of the shorter side of the negative-electrode plate 2 is 4 mm or less, the injection pathway for the electrolytic solution cannot be sufficiently formed. Accordingly, the effect of shortening the injecting time for injecting the electrolytic solution cannot be obtained. Also, when the difference is 10 mm or more, a part which does not serve for power generation enlarges, and the battery capacity decreases. As a result, the difference of 5 mm to 8 mm is more preferable.

Namely, the length of the shorter side of the positive-electrode plate 1 enclosed with the separators is formed shorter than the length of the shorter side of the negative-electrode plate 2 by a length of 4 mm to 10 mm, and the space S is formed at the edge of the positive-electrode plate and between the negative-electrode plates where the negative-electrode plates do not face the positive-electrode plate. Therefore, the space S is formed in the same extent of a size as a thickness of the positive-electrode plate, that is, 50 μm to 200 μm. Since it is preferable that the space S is formed in the same size at the both edges of the positive-electrode plate 1 enclosed with the separators and at both edges of the shorter side of the negative-electrode plate 2, the positive-electrode plate 1, the negative-electrode plate 2, and the separator 3 are laminated according to a centerline thereof.

Although FIGS. 1 and 2 show that the injection pathways are formed at the both edges of the positive-electrode plate, the pathway formed at one edge of the positive-electrode plate can also shorten the injecting time for injecting the electrolytic solution.

Since the positive-electrode plate is enclosed with the separators, the positive-electrode plate and the negative-electrode plate do not face directly, and therefore the occurrence of an internal short-circuit decreases. Also, since the space S is positioned at the edge of the positive-electrode plate between the negative-electrode plates 2, and exposed areas 1a and 2a are laminated successively, pathways for the electrolytic solution can be formed around the entire periphery of the laminated body of the positive-electrode plates 1, each positive-electrode plate being enclosed with the separators, and the negative-electrode plates 2. Therefore, the electrolytic solution can be spread around the periphery quickly so that the electrolytic solution can infiltrate quickly and also uniformly. Accordingly, the separators are less possible to be creased while the electrolytic solution is injected

Further, when the length of the shorter side of the separator 3 is determined as Hs (mm), a relationship between Hs (mm) and Hn (mm) which is the length of the shorter side of the negative-electrode plate 2 is determined as Hn=Hs. Namely, the length of the shorter side of the separator 3 is equal to the length of the shorter side of the negative-electrode 2. It is more preferable that the length of the shorter side of the separator and the length of the shorter side of the negative-electrode plate are exactly the same. However, when the separators and the negative-electrode plates are laminated even though the lengths thereof are not exactly the same but almost substantially the same, the separators and the negative-electrode plates can be easily laminated and the shorter sides thereof can be lined up, and therefore the laminated body can be stabilized and the discordance of the layers does not easily occur. Accordingly, the length of the shorter side of the separator and the length of the shorter side of the negative-electrode plate are preferable to be the same within the range that the workability of the lamination process improves, and the discordance of the layers does not easily occurs during a process(es) after the lamination process. Since the range above can be determined according to the machine accuracy of a manufacturing device used during the lamination process, an operation sequence, and operations after the lamination process, the length of the shorter side of the separator 3 and the length of the shorter side of the negative-electrode plate 2 are better to be almost the same.

After the shorter sides thereof are lined up as described above, longer sides thereof are aligned, and the separators and the negative-electrode plates are laminated.

In addition, although the positive-electrode plates, the negative-electrode plates, and the separators above are described to be in the rectangular form, any of the positive-electrode plates, the negative-electrode plates, or the separators may be square.

Furthermore, although the description above gives some idea of the lengths of the shorter sides of the positive-electrode plate, the negative-electrode plate, and the separator, the lengths of the longer sides thereof are not particularly limited. However, when the length of the shorter side is assumed as 1, a ratio of the length of the longer side is better to be 1 to 5 of the aspect ratio. When its ratio is 5 or more, the injecting time for the electrolytic solution can be shortened since the electrolytic solution is injected through the longer sides, and therefore the effect of shortening the injecting time for injecting the electrolytic solution recited in the present invention need not be achieved. Therefore, when the length of the shorter side is assumed as 1, the ratio of the length of the longer side is more preferable to be 1.2 to 3.

In FIGS. 1 and 2, the separator 3 is shown to be larger than the positive-electrode plate 1, the positive-electrode plate 1 is sandwiched between two sheets of the separators, and the peripheries of the two sheets of the separators are fused around the positive-electrode plate 1. When the peripheries of the two sheets of the separators are fused around the positive-electrode plate 1, the entire peripheries are fused except a portion where is to be an insertion opening for inserting the positive-electrode plate. As a result, the positive-electrode plate 1 is wrapped and enclosed with the separators.

When the peripheries of the separators are fused at prescribed intervals by the heat fusion, except the portion where is to be the insertion opening for the positive-electrode plate, fused sections 3a and unfused sections 3b are formed. As a result, the positive-electrode plate 1 is wrapped and enclosed with the separators. A length of each fused section 3a may be a length in which the separators can be fused, and may be 0.1 mm or less. When the fused section is shorter than 0.1 mm, the injecting time for injecting the electrolytic solution can be shortened. The length of each unfused section 3b is desirable in a length of 0.5 mm to 100 mm. When the length of the unfused section is 100 mm or more, the effect of shortening the injecting time for injecting the electrolytic solution decreases. When the length of the unfused section is 0.5 mm or less, the injecting time for injecting the electrolytic solution can be shortened, but an effect of positioning the positive-electrode plate to stabilize its position decreases.

The fusion of the separators can be carried out by use of a heater block which has the same size as the periphery of each separator. Instead of the heater block, a heater roller may be used. In order to form the fused sections and the unfused sections, concave and convex sections are formed on the heater block or the heater roller in advance.

In FIG. 1, the longer side of the positive-electrode plate 1 is longer than the longer side of the separator 3 in a state in which the positive-electrode plate 1 is enclosed with the separators, and provided with the exposed area 1a which protrudes from the separators. The exposed area 1a welds to a positive-electrode tab (not shown).

The longer side of the negative-electrode plate 2 is longer than the longer side of the separator 3 in a state in which the negative-electrode plates 2 and the positive-electrode plates 1, each positive-electrode plate being enclosed with the separators, are laminated, and the negative-electrode plate is provided with the exposed area 2a which protrudes from the separators. The exposed area 2a welds to a negative-electrode tab (not shown).

The exposed areas 1a and 2a, as shown in FIG. 1, are preferable to be formed at opposite sides to each other in a direction of the longer sides of the positive-electrode plate and the negative-electrode plate so that the exposed areas 1a and 2a are positioned away from each other.

An electrical generating element of the secondary battery of the present invention is formed as the laminated body, as shown in FIG. 2, in which the plurality of the positive-electrode plates 1, each being enclosed with the separators, and the negative-electrode plates 2 are laminated alternately In order to form the laminated body, the number of the negative-electrode plates 2 is preferable to be one plate more than the number of the positive-electrode plates so that two negative-electrode plates 2 can be respectively positioned at top and bottom layers of the laminated body.

One side of the rectangular laminated body, that is, the exposed area 1a which has a prescribed width of the positive-electrode plate 1 welds to the positive-electrode tab as a terminal for taking out a positive electrode (not shown).

Another side which is positioned opposite to the above-mentioned side of the rectangular laminated body, that is, the exposed area 2a which has a prescribed width of the negative-electrode plate 2 welds to the negative-electrode tab as a terminal for taking out a negative electrode (not shown). The laminated body which is welded to the positive-electrode tab and the negative-electrode tab is enclosed with two sheets of the enclosures. FIG. 3 shows a cross-section view of the secondary battery.

Next, the method for preparing the nonaqueous electrolytic solution secondary battery of the present invention will be described.

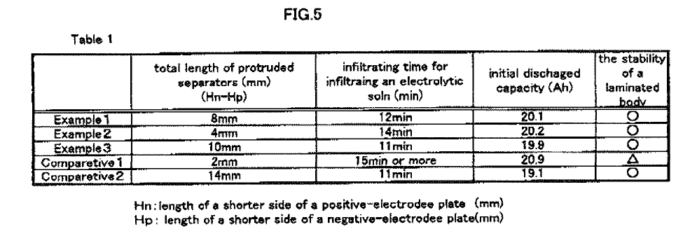

FIG. 4 shows a flow process chart describing the preparation process of the secondary battery of the present invention in order of precedence.

First of all, in the step 1, the positive-electrode plate 1 is prepared such that the paste containing the positive active material, the conductive material, the binder, and the organic solvent is applied on the positive current collector, dried, and pressurized. The separators are respectively superimposed on a topside surface and an underside surface of the positive-electrode plate 1. Next, in the step 2, the peripheries of the separators around the positive-electrode plate 1 are fused. At this time, the entire peripheries of the separators may be fused, but the peripheries except a side where is to be welded to the positive-electrode tab may be fused. Also, when the peripheries are fused, the fused sections and the unfused sections may be alternately formed at the prescribed intervals in repeating fashion.

Instead of carrying out the step 1 and the step 2 as described above, the step 1a and the step 2a can be carried out. In the step 1a, the separators are initially fused in the sac-like form, except the portion where is to be the insertion opening for the positive-electrode plate. When the peripheries are fused, the fused sections and the unfused sections may be alternately formed at the prescribed intervals. Next, in the step 2a, the positive-electrode plate 1 is inserted into the sac-like separator.

Next, in the step 3, the negative-electrode plate 2 is prepared such that the paste containing the negative active material, the conductive material, the binder, and the organic solvent is applied on the negative current collector, dried, and pressurized. Then, the plurality of the positive-electrode plates 1, each positive-electrode plate being enclosed with the separators, and the negative-electrode plates 2 are laminated. In the step 4, each positive-electrode plate 1 is welded to the positive-electrode tab, and each negative-electrode plate 2 is welded to the negative-electrode tab. Next, in the step 5, the laminated body of the positive-electrode plates 1, each positive-electrode plate being enclosed with the separators, and the negative-electrode plates 2 is sandwiched between the enclosures, and three sides of the enclosures are fused except one of the longer sides thereof.

Next, in the step 6, the electrolytic solution is injected through the one side of the enclosure 5, where is not fused. The electrolytic solution may be injected by a method for applying injection pressure to the electrolytic solution, a method for utilizing a pressure difference between negative pressure and atmospheric pressure, and the like. The injecting time for injecting the electrolytic solution can be shortened by these methods. The electrolytic solution passes through the space S as a pathway, the space S being formed at the edge of the positive-electrode plate sandwiched between the negative-electrode plates where the negative-electrode plates do not face the positive-electrode plate, and further passes through the exposed area 1a which is welded to the positive-electrode tab, and the exposed area 2a which is welded to the negative-electrode tab, and then infiltrates through the entire periphery into the whole laminated body. As a result, the positive active material, the negative active material, and the separators are filled with the electrolytic solution. After the positive active material, the negative active material, and the separators are fully filled with the electrolytic solution, the unfused sections are sealed in the step 7 by use of a decompression sealer so as to eliminate air bubbles inside the laminated body, and then the nonaqueous electrolytic solution secondary battery is prepared as shown in FIG. 3.

### EXAMPLE 1

In a process for preparing a positive-electrode plate, N-methyl-2-pyrrolidone (NMP) as a solvent is added to a mixture of a positive active material containing 100 parts by weight of LiMn 204, a conductive material containing 5 parts by weight of acetylene black, and a binder containing 5 parts by weight of PVdF, and the solution is mixed by use of a planetary mixer so as to prepare a positive-electrode paste The prepared paste is uniformly applied on both sides of a belt-like aluminum film which is a positive current collector and has a thickness of 20 μm, by use of a coating device, except a section where is to be uncoated. The aluminum film coated with the paste is dried under reduced pressure at 130° C. for 8 hours, and then pressurized by use of a hydraulic press. The positive-electrode plate is prepared as described above, and is cut to a prescribed size. As a result, the positive-electrode plate having 252 mm in width, 320 mm in length, and 80 μm in thickness is prepared.

In a process for preparing a negative-electrode plate, the NMP as the solvent is added to a mixture of a negative active material containing 100 parts by weight of natural powder graphite (15 μm in average particle diameter) from China, a conductive material containing 2 parts by weight of VGCF powder, and a binder containing 2 parts by weight of PVdF, and the solution is mixed by use of the planetary mixer so as to prepare a negative-electrode paste. The prepared paste is uniformly applied on both sides of a copper film which is a negative current collector and has a thickness of 10 μm, by use of the coating device, except a section where is to be uncoated. The copper film coated with the paste is dried under reduced pressure at 100° C. for 8 hours, and then pressurized by use of the hydraulic press. The negative-electrode plate is prepared as described above, and is cut to a prescribed size. As a result, the negative-electrode plate having 260 mm in width, 325 mm in length, and 55 μm in thickness is prepared.

The separator is microporous polypropylene having 260 mm in width, 335 mm in length, and 20 μm in thickness. The positive-electrode plate is sandwiched between two film-like separators, and a total length of the separators, which protrude in a direction of shorter sides (width) of the positive-electrode plate, is set to be 8 mm. The separators protruded from the positive-electrode plate are fused by a width of 1 mm at intervals of 1 mm.

A plurality of the positive-electrode plates, each being enclosed with the separators, and the negative-electrode plates are alternately laminated by being aligned in a direction of shorter sides of the positive-electrode plates and the negative-electrode plates, and a laminated body thereof is formed.

One side of this rectangular laminated body, that is, the uncoated section of the positive-electrode plate is ultrasonic-welded to a positive-electrode tab formed of aluminum.

Also, other side of this rectangular laminated body, that is, the uncoated section of the negative-electrode plate is ultrasonic-welded to a negative-electrode tab formed of nickel. The laminated body to which the positive-electrode tab and the negative-electrode tab are welded is enclosed with two enclosures, each enclosure comprising a three-layer laminated film in which an aluminum film of 50 μm in thickness is sandwiched between two polypropylene resin films of 30 μm in thickness, and three sides of the enclosure are fused.

Next, a solution in which LiPF 6 dissolves in a solvent containing ethylene carbonate and diethylene carbonate in a volume ratio of 1:2 so as to have a density of 1.0 mol/L is injected through an unfused side of the enclosure. Then, the unfused side of the enclosure is heat-fused, and a lithium ion secondary battery is prepared.

### EXAMPLE 2

In Example 2, two separators are cut to a width of 256 mm, and a negative-electrode plate is cut to a width of 256 mm. A positive-electrode plate having the same size as that of Example 1 is sandwiched between the two separators. A total length of the separators, which protrude in the direction of the shorter sides (width) of the positive-electrode plate, is set to be 4 mm. A secondary battery is prepared through the same procedure as that in Example 1 except the total length above.

### EXAMPLE 3

In Example 3, two separators are cut to a width of 262 mm, and a negative-electrode plate is cut to a width of 262 mm. A positive-electrode plate having the same size as that of Example 1 is sandwiched between the two separators. A total length of the separators, which protrude in the direction of the shorter sides (width) of the positive-electrode plate, is set to be 10 mm. A secondary battery is prepared through the same procedure as that in Example 1 except the total length above.

### COMPARATIVE EXAMPLE 1

In Comparative Example 1, two separators are cut to a width of 254 mm, and a negative-electrode plate is cut to a width of 254 mm. A positive-electrode plate having the same size as that of Example 1 is sandwiched between the two separators. A total length of the separators, which protrude in the direction the shorter sides (width) of the positive-electrode plate, is set to be 2 mm. A secondary battery is prepared through the same procedure as that in Example 1 except the total length above.

### COMPARATIVE EXAMPLE 2

In Comparative Example 2, two separators are cut to a width of 266 mm, and a negative-electrode plate is cut to a width of 266 mm. A positive-electrode plate having the same size as that of Example 1 is sandwiched between the two separators A total length of the separators, which protrude in the direction the shorter sides (width) of the positive-electrode plate, is set to be 14 mm. A secondary battery is prepared through the same procedure as that in Example 1 except the total length above.

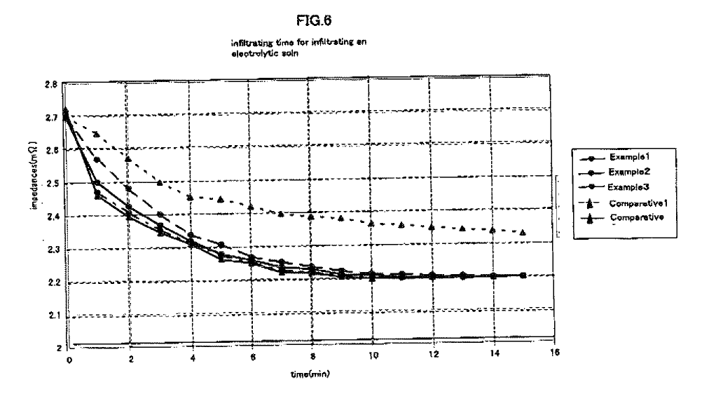

Table 1 of FIG. 5 shows results of infiltrating time for infiltrating an electrolytic solution, an initial discharged capacity (Ah), and the stability of the laminated body, in regard to each of the lithium ion secondary batteries prepared in Examples 1 to 3 and Comparative Examples 1 and 2.

The infiltrating time for infiltrating the electrolytic solution is defined as time for infiltrating the electrolytic solution uniformly into the entire battery, and injecting time for injecting the electrolytic solution during a process for injecting the electrolytic solution is also included in the infiltrating time. The infiltrating time for infiltrating the electrolytic solution was measured by the impedance method from when a prescribed amount of the electrolytic solution was initially injected to when a stable impedance was indicated as time passed. Incidentally, a frequency for measuring the infiltrating time for infiltrating the electrolytic solution was 1 kHz.

FIG. 6 shows measurements results of alternating-current impedances in Examples 1 to 3 and Comparative Examples 1 and 2.

The initial discharged capacity (Ah) is a discharged capacity in which the secondary battery is discharged down to 3.0 V at a rate of 0.1 CmA after being charged up to 4.2 V at a rate of 0.1 CmA.

The stability of the laminated body is indicated as ◯ when discordance of the electrode plates is less than 1 mm, Δ when the discordance is from 1 mm or more to less than 2 mm, and when the discordance is 2 mm or more, after the laminated body is measured by X-rays.

As shown in Table 1 of FIG. 5 and FIG. 6, when the total length is from 4 mm or more to 10 mm or less as described in Examples 1 to 3 measured by subtracting a length (Hp) of the shorter side of the positive-electrode plate from a length (Hn) of the shorter side of the negative-electrode plate, the infiltrating time for infiltrating the electrolytic solution was approximately 14 minutes at the latest until the electrolytic solution was completely infiltrated. On the other hand, when the total length which is Hn−Hp is 2 mm as described in Comparative Example 1, the electrolytic solution was not completely infiltrated even after time passed for 15 minutes and more. Also, the total length of 14 mm which is Hn−Hp described in Comparative Example 2 showed for a first few minutes a slightly lower impedance than impedances in Examples 1 to 3, but time for stabilizing the impedance in Comparative Example 2 was almost the same as those in Examples 1 to 3.

As shown in Table 1, the initial discharged capacities in Examples 1 to 3 in which the total length of Hn−Hp was from 4 mm or more to 10 mm or less were around 20.0 Ah and stable. On the other hand, the initial discharged capacity in Comparative Example 2 in which the total length of Hn−Hp was 14 mm was approximately 1 Ah and low.

In Comparative Example 2, a difference between the length of the shorter side of the positive-electrode plate and the length of the shorter side of the negative-electrode plate is too large. Accordingly, since the separators which protrude toward the negative-electrode plate are too large, and area where cannot give and receive lithium ions in the secondary battery increases, a battery capacity decreased significantly.

As shown in Table 1, the stability of the laminated body in Examples 1 to 3 in which the total length of Hn−Hp was from 4 mm or more to 10 mm or less was stable. On the other hand, the discordance of the electrode plates in Comparative Example 1 in which the total length of Hn−Hp was 2 mm was from 1 mm or more to less than 2 mm.

In Examples 1 to 3, the electrode plates have large areas, and a length Hs (mm) of a shorter side of the separators which enclose the positive-electrode plate is the same as the length Hn (mm) of the shorter side of the negative-electrode plate. As a result, a direction of the shorter side of the separators can align with a direction of the shorter side of the negative-electrode plate, and therefore it is advantageous that the discordance of the layers can be minimized.

Consequently, when a stable large-scale lithium ion secondary battery is prepared, the present invention is significantly effective at minimizing discordance of layers of large electrode plates during a process for laminating them, and shortening infiltrating time for infiltrating an electrolytic solution during a process for injecting the electrolytic solution since a length Hp (mm) of a shorter side of a positive-electrode plate enclosed with separators and a length Hn (mm) of a shorter side of a negative-electrode plate has a relationship of Hp<Hn and 4 (mm)≦Hn−Hp≦10 (mm), a space having a width of Hn−Hp is positioned between the negative-electrode plates and at where the negative-electrode plates do not face the positive-electrode plate, and a length Hs (mm) of the separators and the length Hn (mm) of the shorter side of the negative-electrode plate have a relationship of Hn=Hs.

What is claimed is:

1. A nonaqueous electrolytic solution secondary battery comprising:
negative-electrode plates which are rectangular;
positive-electrode plates which each have a pair of opposed sides shorter than a pair of opposed sides of each negative-electrode plate;
separators which each are formed of a porous resin film enclosing each positive-electrode plate;
an enclosure which encloses the negative-electrode plates and separators which are laminated alternately, in which a direction of the sides of the negative-electrode plates aligns with a direction of the shorter sides of the positive-electrode plates; and
an injection pathway for the nonaqueous electrolytic solution, which the pathway being formed between the negative-electrode plates between which the separator is sandwiched, the pathway being formed at edges of opposed sides of the negative-electrode plates.

2. The nonaqueous electrolytic solution secondary battery according to claim 1, wherein a length of the pair of the opposed sides of each positive-electrode plate is shorter by a length of 4 mm to 10 mm than a length of the pair of the opposed sides of each negative-electrode plate.

3. The nonaqueous electrolytic solution secondary battery according to claim 1, wherein each separator has a length of a pair of opposed sides which is almost the same as the length of the pair of the opposed sides of each negative-electrode plate.

4. The nonaqueous electrolytic solution secondary battery according to claim 1, wherein a capacity of each positive-electrode plate is 3 Ah to 5 Ah per plate, and a battery capacity of the nonaqueous electrolytic solution secondary battery is 5 Ah to 150 Ah.

5. The nonaqueous electrolytic solution secondary battery according to claim 1, wherein an electric capacity of each positive-electrode plate is 2 mAh to 12 mAh per square centimeter.

6. The nonaqueous electrolytic solution secondary battery according to claim 1, wherein the periphery of each separator is fused.

7. The nonaqueous electrolytic solution secondary battery according to claim 6, wherein each separator has fused sections and unfused sections which are alternately positioned at the periphery of the separator, in which a length of each fused section is 0.1 mm to 20 mm, and a length of each unfused section is 0.5 mm to 100 mm.

8. The nonaqueous electrolytic solution secondary battery according to claim 1, wherein one of the pair of the opposed sides of each separator is open, the side facing the shorter side of the positive-electrode plate, and other sides of the separator are fused.

9. A method for preparing a nonaqueous electrolytic solution secondary battery, comprising the steps of:
alternately laminating negative-electrode plates and separators, each separator enclosing one positive-electrode plate having a pair of opposed sides shorter than a pair of opposed sides of each negative-electrode plate;
enclosing a laminated body with an enclosure having an injection opening for the electrolytic solution, the laminated body being laminated during the lamination step;
injecting the electrolytic solution through the injection opening to infiltrate the electrolytic solution between the negative-electrode plate and the positive-electrode plate through an injection pathway formed at edges of opposed sides of the negative-electrode plates; and
sealing the injection opening.
